(19) United States
(12) Patent Application Publication
(10) Pub. No.: US 2006/0085412 A1
(43) Pub. Date: Apr. 20, 2006

(54) System for managing multiple disparate content repositories and workflow systems

(76) Inventors: Sean Allen Johnson, Charlotte, NC (US); Jeffrey Boyd Rayfield, Charlotte, NC (US); Louis Girard Gates, Charlotte, NC (US); Robert Earl White, Charlotte, NC (US); Andrew Benjamin Jenkins, Charlotte, NC (US)

Correspondence Address: INTERNATIONAL BUSINESS MACHINES CORP;IP LAW, 555 BAILEY AVENUE , J46/G4, SAN JOSE, CA, 95141, US

(21) Appl. No.: 10/825,622

(22) Filed: Apr. 15, 2004

Related U.S. Application Data
(60) Provisional application No. 60/462,976, filed on Apr. 15, 2003.

(51) Int. Cl. G06F 17/30

(52) U.S. Cl. 707/4

(57) ABSTRACT

A system for managing content and work items in a plurality of disparate content repositories and workflow systems. The first module organizes content, content organizing structures, work items, and/or work organizing structures into virtual repositories. The second module provides access to workflow in disparate workflow systems having a plurality of proprietary program interfaces. The third module creates rich relationships between two or more pieces of content, content organizing structures, work items and/or work organizing structures that exist in a plurality of content repositories, workflow systems and/or other external information sources. The fourth module provides notification of one or more event handlers when additions, changes or deletions occur to any subscribed to content, content organizing structures, content repository searches, federated content repository searches, work items, work organizing structures, workflow system searches and/or federated workflow system searches that exist in a plurality of content repositories, workflow systems and/or other external information sources.

### BACKGROUND OF THE INVENTION

This application claims the benefit of the provisional application No. 60/462,976 filed on Apr. 15, 2003 and U.S. application Ser. No. 09/824,694, filed on Apr. 3, 2001.

The present invention relates to content repositories and, more particularly, to a software system for creating virtual content repositories, providing workflow integration, relating content from dissimilar repositories and workflow systems, and generating notice of changes to content repositories and workflow systems.

Over the past few decades, most business enterprises have developed custom technologies to increase business productivity. Thus, unstructured content of many types has emerged, including office documents, product collateral, contracts, order forms, presentations, e-mails, invoices, CAD/CAM diagrams, design specifications, web pages, images, audio, and video, just to name a few. These content assets have become especially important to business enterprises in large industries such as financial services, manufacturing, pharmaceuticals, and government agencies, where many separate applications are used to generate documents and other unstructured content stored in dedicated repositories. In order to manage their content assets, these business enterprises have selected various content-controlling systems, including document management, imaging, enterprise report management, product data management (PDM), web content management, report management, collaborative tools, web publishing systems, and the like.

In order to compete in today's global society, these enterprises must be able to access, integrate, and exchange content assets with frequency and speed. While the explosion of the Internet has eroded some access and exchange barriers, mechanisms for real-time content delivery from disparate content repositories are still needed. For example, large enterprises often acquire content repositories from different vendors to support specific business functions within the enterprise. It is practically impossible for a user to interact with the content from the multiple disparate content repositories when new business activities require the user to have such interaction. This is because the content has been organized, indexed and secured in a manner that is most conducive to the original business context. The content cannot be reorganized, re-indexed and re-secured to support the new business function because it must still support the existing business function.

Likewise, when business activities require a user to interact with workflow processes from multiple disparate workflow engines and the content that supports the workflow processes comes from multiple disparate content repositories, it is impossible for the supporting system to be able to access the underlying engines and repositories using their respective application programming interfaces (API).

Further, the content and work items that exist within content repositories and workflow systems typically have rich facilities for describing their respective content and work items. However, the content and work items in these disparate systems have relationships between them that are not captured in each respective repository or workflow system due to the system's focus on supporting its own individual business function.

Similarly, because each content repository or workflow system is focused on its own business function, when additions, changes, deletions are made to their respective content or work items, it is practically impossible for users and applications to monitor such modifications. This is especially the case where many different users have the ability to modify content or work items at any time with any number of different mechanisms. It is practically impossible to generate a consistent notification of these types of changes because the systems are dissimilar.

Accordingly, there is a need in the art for a system that provides a single, consistent method to integrate, access, exchange, update, and notify users and applications of changes to content and work items stored in multiple disparate content repositories and workflow systems, regardless of the underlying systems used to manage the content.

### SUMMARY OF THE INVENTION

The present invention solves this need in the art by providing a system having four modules for creating virtual content repositories, providing workflow integration, relating content from dissimilar repositories and workflow systems, and generating notice of changes to content repositories and workflow systems.

The first module is a system for virtually organizing content, content organizing structures, work items, and/or work organizing structures from a plurality of disparate content repositories and/or workflow systems. The system includes an application program interface (API) for interfacing with a software application written to provide access to the system, and at least one virtual repository. The at least one virtual repository includes a plurality of nodes that link to select items from the plurality of content repositories and/or workflow systems and provide organizational structure for the virtual repository.

The second module is a system for providing access to workflow in a plurality of disparate workflow systems having a plurality of proprietary program interfaces. The system includes an application program interface (API) for interfacing with a software application written to provide access to the system, an access services component that relays requests to access workflow items in the plurality of workflow systems from the API to a plurality of bridges, and a plurality of bridges that translate user requests into requests understandable by the proprietary program interfaces of the plurality of disparate workflow systems.

The third module is a system for creating rich relationships between two or more pieces of content, content organizing structures, work items and/or work organizing structures that exist in a plurality of content repositories, workflow systems and/or other external information sources. The system includes an application program interface (API) for interfacing with a software application written to provide access to the system.

A system of nodes, members, and associations is used to describe the relationships between the two or more pieces of content, content organizing structures, work items and/or work organizing structures.

The fourth module is a system for providing for notification of one or more event handlers when additions, changes or deletions occur to any subscribed to content, content organizing structures, content repository searches, federated content repository searches, work items, work organizing structures, workflow system searches and/or federated workflow system searches that exist in a plurality of content repositories, workflow systems and/or other external information sources. The system includes including an application program interface (API) for interfacing with a software application written to provide access to the system. The system also includes subscriptions to content, content organizing structures, content repository searches, federated content repository searches, work items, work organizing structures, workflow system searches and/or federated workflow system searches. The subscriptions are requests to track when additions, changes or deletions occur to any subscribed to content, content organizing structures, content repository searches, federated content repository searches, work items, work organizing structures, workflow system searches and/or federated workflow system searches.

### BRIEF DESCRIPTION OF THE DRAWINGS

The present invention is better understood by a reading of the Detailed Description of the Preferred Embodiments along with a review of the drawings, in which:

FIG. 1 is a block diagram of the virtual repository module of the present invention.

FIG. 2 is a block diagram of the workflow system integration module of the present invention.

FIG. 3 is a block diagram of the content relationship module of the present invention.

FIGS. 4 and 5 are block diagrams of the event notification module of the present invention.

### DETAILED DESCRIPTION OF THE PREFERRED EMBODIMENTS

The illustrations and examples discussed in the following description are provided for the purpose of describing the preferred embodiments of the invention and are not intended to limit the invention thereto.

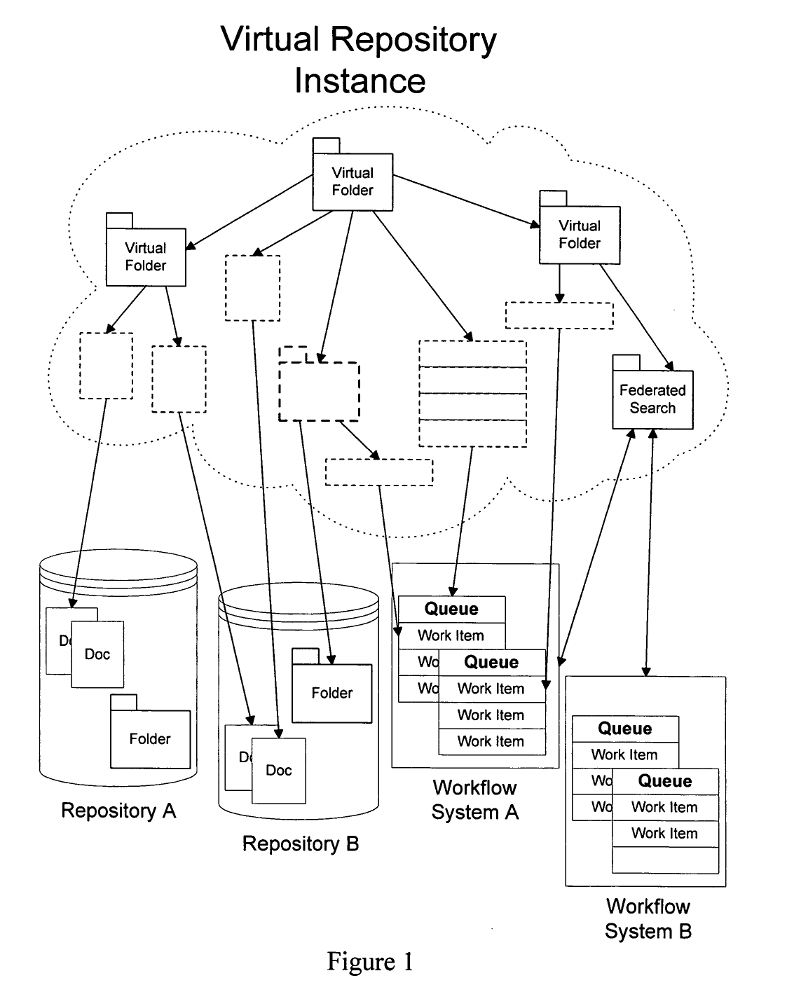

As shown in FIG. 1, the software system of the present invention comprises four modules for creating virtual content repositories, providing workflow system integration, relating content from dissimilar repositories and workflow systems, and generating notice of changes to content repositories and workflow systems.

As explained in further detail below, these components are preferably created and configured with an application programming interface (API) and a user interface. The API is preferably available in Java, Component Object Model (COM), Simple Object Protocol (SOAP) Web Services, Representational State Transfer (REST) Web Services, and Web Development Components. The user interface is preferably available in a graphical user interface and in a web-based user interface.

The multi-tiered architecture of the present system provides content repository and workflow system location transparency to client applications and manages communication with the underlying systems. An adaptor architecture is also provided that allows the system to extend to additional content repositories and workflow systems that are developed in the future.

Virtual Repositories

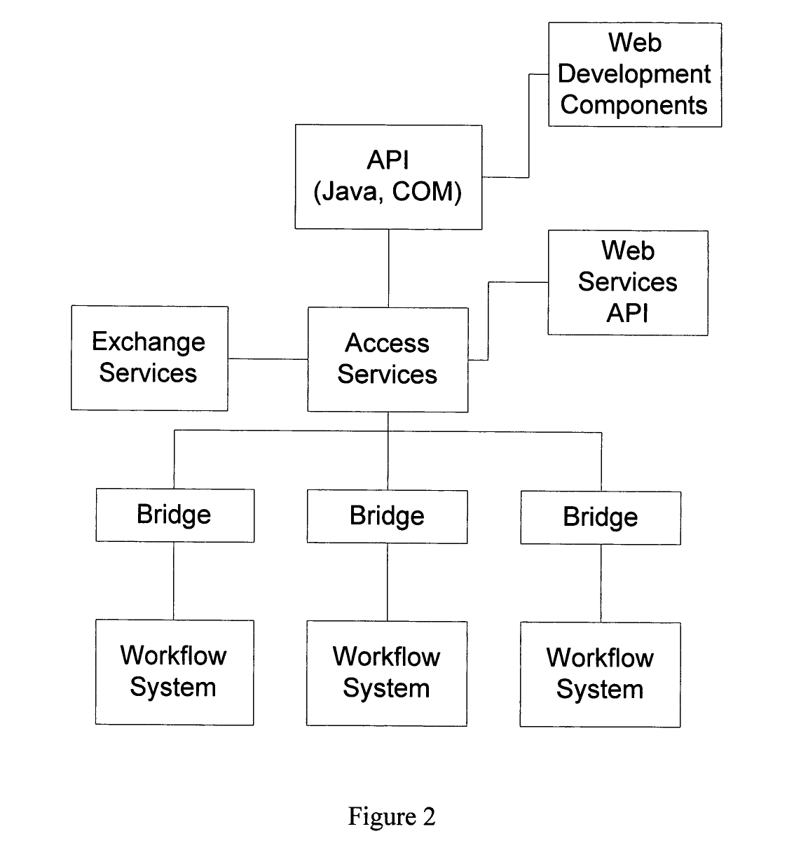

As shown in FIG. 2, the software system of the present invention supports the creation of instances of virtual repositories that include content, content organizing structures (e.g. folders, folder hierarchies, taxonomies), work items, and/or work organizing structures (e.g. queues, task lists, processes) from a plurality of disparate and distributed content repositories and workflow systems. These virtual repositories allow a select, relevant subset of the content and work from the plurality of content repositories and workflow systems available in an enterprise to be virtually isolated, organized, and secured to support a new business context, despite how the content and work may have been initially grouped into repositories and workflow systems and organized therein. This virtual reorganization is achieved by creating links between the content and work while they are in place in their respective, existing content repositories or workflow systems, rather than by duplicating or replicating the content and work items. Thus, the existing organization, functions, indexing, and security of the content and work is not impacted.

In a preferred embodiment, each virtual repository is made up of a parent-child hierarchy of nodes. Each node can be one of many types including a link to a folder in a content repository, a link to a specific version of content in a content repository, a link to the latest version of content in a content repository, a link to a work item in a workflow system, a link to a workflow queue or task list, a link to a saved search of a content repository or a saved multiple repository federated search of many content repositories, a link to an external system resource via an universal resource locator (URL), or a virtual folder that exists only in the virtual repository and serves an organizing function.

Nodes may contain additional meta-data describing how the particular content, content organizing structures (folders, folder hierarchies, taxonomies), work item and/or work organizing structures (queues, task lists, processes) is used within the context of the virtual repository. Nodes may further have supplemental access control rules applied to them that dictate the security constraints to their use within the new business context being supported by the virtual repository. All such access control is supplemental to the access control already provided by the underlying content repositories and workflow systems, which cannot be violated by the system.

In a preferred embodiment, the system provides for the seamless import and export of one or more virtual repositories in an XML format. Access services ability to map meta-data fields supports the dynamic movement of work between disparate repositories.

The system of the present invention further leverages content integration middleware and workflow integration middleware to provide independence of the system from the vendor specific details of the plurality of content repositories and workflow systems. Such middleware addresses the market-leading content repositories and workflow systems and is able to extend to additional content repositories and workflow systems as new systems are created or enterprises invest in alternative systems.

The present system also preferably leverages a persistent store optimized for object graph storage and traversal to provide for long-term persistence of the instances of virtual repositories. Additionally, the present system leverages a caching algorithm optimized for object graph caching and traversal to provide for caching of the instances of virtual repositories.

The ability to create virtual repositories from a plurality of disparate and distributed content repositories and workflow systems, as described above, is advantageous because once content is made available in a virtual repository, the repository can be linked to the relevant business objects within the enterprise's other information systems so that each process, topic or business object in the enterprise is linked to a virtual view of all the relevant content and work items that support it.

Workflow Integration

The software system of the present invention also aids in integrating multiple dissimilar and distributed workflow systems. Particularly, the software system, comprising the API and a user interface, provides unified access to the capabilities of multiple dissimilar and distributed workflow systems. This interface provides a superset of the capabilities of existing commercial workflow systems by allowing users and programs to access and manipulate work items and work organizing structures (e.g. queues, task lists, processes) managed in any workflow system while remaining independent and unaware of the particular workflow system that is being accessed.

Similarly, the API and user interface of the software system of the present invention attach content, content organizing structures, and work items that support a work item or process to any work item. The underlying content, content organizing structures, and work items may come from multiple dissimilar and distributed repositories and workflow systems.

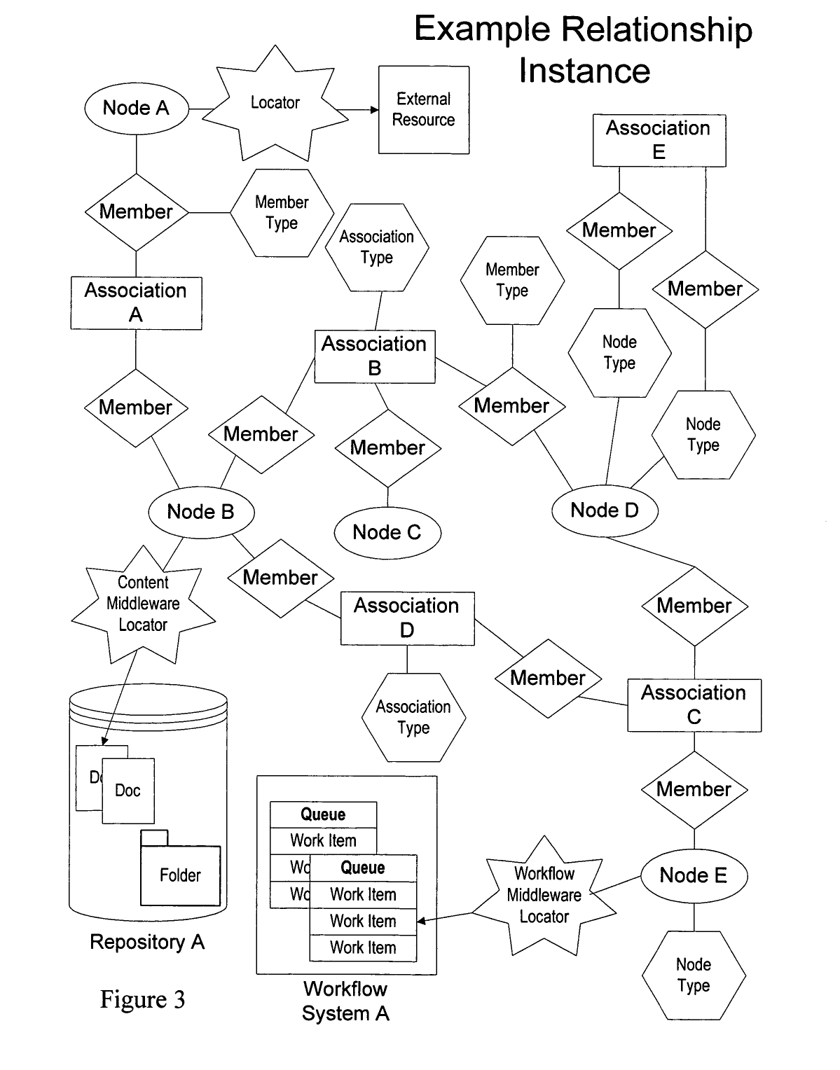

As shown in FIG. 3, the embodiment of the present system relating to integration of workflow systems generally comprises an application program interface (API), an access services component, an exchange services component, and a plurality of bridges that correspond with a plurality of workflow systems.

The API provides the functionality of existing commercial workflow systems by enabling the development of software applications that can access the functionality of workflow systems without using the vendor specific APIs for each workflow system or being aware of the type, vendor or location of each workflow system. Specifically the API enables searching, federated searching, update, display, creation, and management of work items and work organizing structures in a plurality of workflow systems using a single, consistent interface.

The core server component of this embodiment is the access services server. This server co-component is preferably made up of Enterprise JavaBeans (EJBs) deployed in a Java 2 Enterprise Edition (J2EE) compliant server container. The server may run on a wide variety of platforms including Solaris, HP-UX, AIX, Linux, Mac OS X and Windows. The server components may run from a single server computer or be distributed across several computers to enhance the performance and scalability of the overall system.

The access services component acts as the interface between requests from the API and the plurality of workflow systems. Specifically, access services relays the requests to the appropriate workflow systems via bridges. Access services also aggregates the results of requests to multiple systems and returns the information to the API. Access services further provides a data dictionary that maps meta-data properties across different workflow systems to solve problems of inconsistent meta-data naming, data type, formatting and allowed values. The data dictionary references these different meta-data fields in each workflow system under a single, uniform alias. This feature enables users of the API to use the common alias when accessing or searching any or multiple of the plurality of workflow systems.

As noted above, the API enables searching, federated searching, update, display, creation, and management of work items and work organizing structures in a plurality of workflow systems using a single, consistent interface. Access services enables the system to perform these functions. Particularly, access services enables an application to access all the functionality of a workflow system.

The bridges translate requests from access services into requests that can be understood by the proprietary, vendor specific APIs of the plurality of workflow systems. Thus, the system enables an enterprise to access all the functionality of its workflow systems without depending on the vendor specific interfaces of each workflow system. Preferably, each bridge is an Enterprise JavaBean (EJB) deployed in a Java 2 Enterprise Edition (J2EE) server container. Each bridge preferably answers requests from access services through Java, Remote Method Invocation (RMI), Simple Object Access Protocol (SOAP) Web Services or IIOP (CORBA) and services requests by invoking the underlying workflow system through Java, Component Object Model (COM), Java Native Interface (JNI) or Simple Object Access Protocol (SOAP) Web Services API calls. Each bridge provides access to a workflow system and may be modified or extended to support unique, customized or non-standard implementations of the workflow system. In addition, the system enables an enterprise to rapidly develop and implement new bridges to accommodate additional workflow systems. When a new bridge is created to support a new workflow system, all remaining components of the system remain in tact and unchanged.

The exchange services component provides the seamless import and export of work items and work organizing structures in the plurality of repositories in an XML format. Access services' ability to map meta-data fields, as discussed above, supports the dynamic movement of work between disparate repositories.

The present system leverages content integration middleware and a mechanism for universal content referencing and work item attachment to support attaching content from any content repository to work items from any workflow system. This is an improvement over the state of the art where one workflow system is integrated to only 0 or 1 content repository and only supports attaching content from the single repository or not at all.

The process described above of enabling access to the functionality of multiple, disparate workflow systems with a single, consistent interface is advantageous because it allows the enterprise to consistently access, manage and exchange work items and work organizing structures regardless of how many disparate workflow systems the enterprise uses. This system does not replace the existing workflow systems. Rather, it unifies them because the bridges are able to transcend the incompatible APIs, vendor barriers, and technology differences, as well as differences between workflow system types such as process workflow, ad-hoc workflow, business process management, document-centric workflow, administrative workflow and simple task management systems. Therefore, enterprises using the system are able to locate, retrieve, create, and manage work items and work organizing structures regardless of what system the items are in. Enterprises are able to focus on business solutions rather than maintaining multiple costly integrations to incompatible workflow systems. Independent software vendors can use the invention to deliver business solutions to the market that are independent of any workflow system or vendor allowing the customer to select the workflow system and vendor that is, in their opinion, most appropriate for the organization and the specific application.

Content Relationships

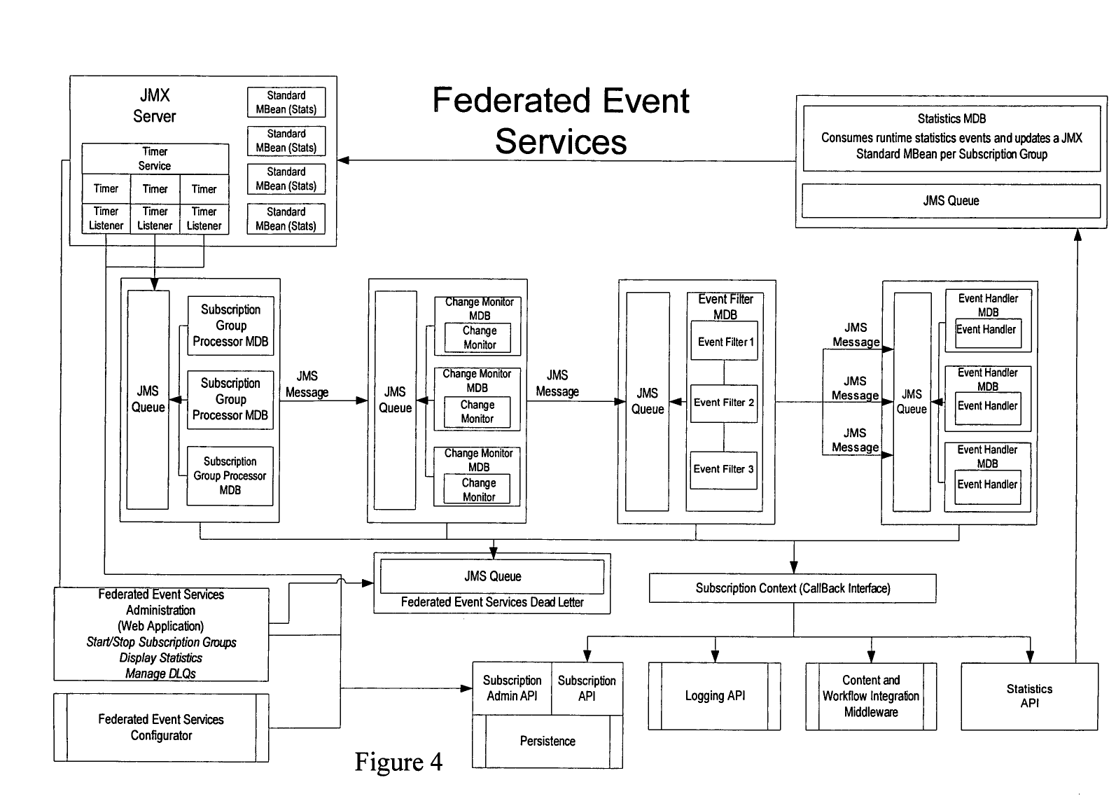

The software of the present invention further provides for the creation of relationships between content or work items from multiple dissimilar and distributed repositories and workflow systems. As shown in FIG. 4, the API enables the creation of rich relationships between two or more pieces of content, content organizing lo structures (folders, folder hierarchies, taxonomies), work items and/or work organizing structures (queues, task lists, processes), even when the related items exist in a plurality of content repositories, workflow systems and/or other external information sources. The relationships between items can be very rich with relationship types, metadata about the relationship, logical properties of the relationship such as transitivity, system behaviors across the relationship such as save and delete propagation, and the like. The relationships themselves can also be the object of relationships with other content, content organizing structures, work items, and/or relationships. A locator architecture is defined that allows the solution to be extended to additional content repositories, workflow systems and other external information sources.

In order to create the content relationships, the present system preferably supports the concept of a node. A node is generally either an entity defined by a unique subject identifier or is a piece of external information defined by a unique subject address that can be resolved with a locator.

Locators are used to reference and de-reference entities external to the system. In a preferred embodiment, a locator exists for uniquely identifying and de-referencing content or content organizing structures that are accessible in a plurality of content repositories via content integration middleware. In a preferred embodiment, a locator exists for uniquely identifying and de-referencing work items or work organizing structures in a plurality of workflow systems that are accessible via workflow integration middleware. Preferably, the locator mechanism is extensible and additional locators to other types of external systems can be added without changing the other components of the system.

Nodes support any arbitrary meta-data that serves to describe any aspect of the node. One particular set of meta-data nodes have a name and 0 or more scoped names. The name is an identifier for the node and the scoped names are names that apply only in certain circumstances. For instance, the name of a node may be “Venetica Contract” and the name scoped to “Full Name” may be “Venetica Contract—Version 3—Jan. 16, 2003” and the name scoped to “Spanish” may be “Venetica <Spanish for Contract>”.

Nodes can play a role in an association with another node through membership in an association and in this way, associating content and workflow items from a plurality of content repositories and workflow systems is realized.

Nodes may have 0 or more node types. A node type defines the type of item the node is and application level business rules may be applied to this type, such as “Nodes of type ‘A’ have meta-data fields ‘a’, ‘b’, and ‘c’ and may participate in binary relationships with nodes of type ‘B’”. Node types are also nodes and therefore have all the characteristics of a node including the ability to participate as members of an association.

Associations are the relationship between two or more nodes. Associations have two or more members of the association which are nodes playing a specific role in the relationship. For example a “Parent—Child” relationship may have a “Mother” member and a “Son” member or a “Author” relationship may have a “Text” member and five “Writer” members. Associations are also nodes and therefore have all the characteristics of a node specified above, including the ability to participate as members of an association.

Associations can have 0 or more association types that describe the type of the association. Association types have logical properties about the relationship such as the allowed members of the relationship, the required members of the relationship, the allowed cardinality of any particular member of the relationship, the delete propagation direction across the relationship, if any, and the save propagation direction across the relationship, if any. Association types are also nodes and therefore have all the characteristics of a node specified above including the ability to participate as members of an association.

Members are the specific role a node plays in an association such as “Mother” in a “Parent—Child” relationship or “Captain” in a “Crew” relationship. Members have a player, which is a reference to the node playing the particular role in the association and a reference to the association.

Members may have 0 or more member types. A member type defines the type of item the member is and application level business rules may be applied to this type. Such as “Members of type ‘A’ have to be Nodes of type “B” or type “C”. Member types are also nodes and therefore have all the characteristics of a node, including the ability to participate as members of an association.

In a preferred embodiment, the system leverages a persistent store optimized for object graph storage and traversal to provide for long-term persistence of the instances of nodes, associations, members and the various types. Similarly, it is preferred that the system leverage a caching algorithm optimized for object graph caching and traversal to provide for caching of the instances of nodes, associations, members and the various types.

The process described above of creating rich relationships between two or more pieces of content, content organizing structures (e.g. folders, folder hierarchies, taxonomies), work items and/or work organizing structures (e.g. queues, task lists, processes), even when those items exist in a plurality of content repositories, workflow systems and other external information sources, is advantageous because it allows the organization to locate, track, manage and secure relationships between items. These items would otherwise be lost or only retained in the author's memory or notes where it is understandably prone to being lost and is not available to the rest of the organization.

In prior art systems, repositories of content and workflow systems manage only relationships between content in their own system and, in certain vendors, unidirectional relationships out to other sources. The prior art does not provide a system for having these types of rich relationships between repository isolated items that is both bi-directional and capable of addressing a large number of disparate content repositories, workflow items and other information systems. Not having these rich relationships leads to poor decision making due to not leveraging all the relevant information. Not having these relationships also leads to the expensive duplication of content that is not known to already exist, and leads to data and knowledge consistency problems as changes are made to items without understanding or reflecting the changes impact on related materials.

Event Notification

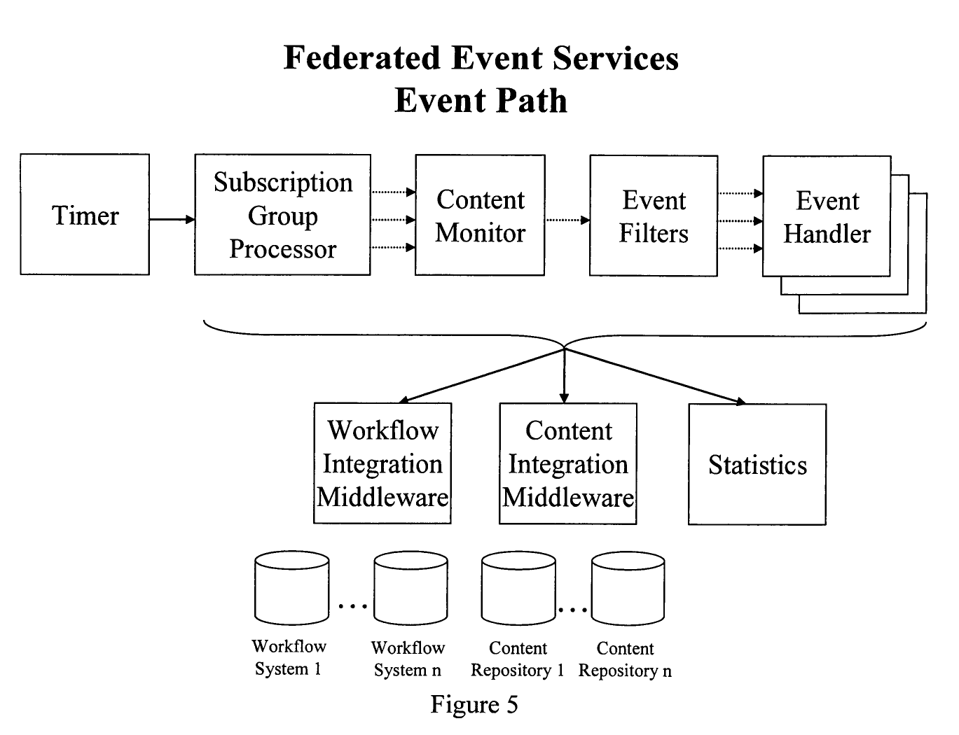

As shown in FIGS. 5 and 6, the software system of the present invention further provides for notification of one or more event handlers when additions, changes or deletions occur to any subscribed to content, content organizing structures (e.g. folders, folder hierarchies, taxonomies), content repository searches, federated content repository searches, work items, work organizing structures (e.g. queues, task lists, processes), workflow system searches and/or federated workflow system searches, even when those items exist in a plurality of dissimilar and distributed content repositories, workflow systems and other external information sources. The software provides a “plug-in” architecture that allows the solution to be extended with additional types of change monitors, event filters and event handlers.

In a preferred embodiment, subscriptions to content, content organizing structures, content repository searches, federated content repository searches, work items, work organizing structures, workflow system searches and federated workflow system searches from a plurality of content repositories and workflow systems can be created and persisted in the system. A subscription is a request to track one or more items and monitor it for change, deletion or the addition of parts. Subscriptions support persisting any meta-data about the subscription needed for the monitoring of the subscription, the handling of events or any other system or application purpose. The content repository or workflow system user credentials for the subscribed to item or items are retrieved from the item and encrypted and stored with the subscription as meta-data so they may be used for polling based monitoring later if polling based monitoring is needed. The latest state of the item or items may also be stored as meta-data with the subscription, preferably in an XML format, so that it may be compared at a later point to the state of the item or items to detect changes. Subscriptions are organized into subscription groups.

Subscription groups serve as a logical unit of organization for multiple like subscriptions. The group provides a place for subscription management without the need to manage each subscription individually. Subscription groups specify the polling interval if changes are being detected by polling and also specify the event path for all the subscriptions in the group.

An event path is a sequence of steps that the subscription events of the subscriptions of a subscription group will flow through. The steps consist of a timer, group processor, content monitor, event filter and event handler steps. A single timer, group processor and content monitor are specified in an event path and 0 or more event filters and I or more event handlers. Event filters are processed serially, and event handlers in parallel.

In a preferred embodiment, the system provides a mechanism for configuring the event path of each subscription group. The configuration API provides the interface for a software application written to configure the system.

When the items of a subscription are to be monitored for change, either based on a polling interval elapsing or the receipt of a change notification from an external system, an event is created. The event provides access to the subscription the event is for, meta-data describing the event, any steps that have been taken place thus far on the event and any arbitrary data needed by event services plug-ins processing the event, and the event path, or sequence of steps that the event will follow to be processed. The event is defined and described in detail so any system may create events without necessitating scheduled polling for events and those events may be introduced at any appropriate step within the event path.

In the case where a system being monitored is not capable of posting events based on change in items of the system, a polling mechanism with a timer interval is used. The timer system initiates periodic polling of the subscriptions. A filtering mechanism is provided to filter out undesired timing events (such as events during holidays, or after business hours, or events during business hours, et cetera).

In a preferred embodiment, the system hosts a subscription group processor plug-in module that creates events for each eligible subscription in the subscription group. Eligibility is defined by the subscription group processor and is variable but usually includes concepts such as not being suspended by the user or the system and not having stale credentials.

The system also preferably hosts a content monitor plug-in module that detects changes in the items being monitored by the subscription. In a preferred embodiment, there is at least one content monitor that leverages content integration middleware and workflow integration middleware to detect changes from a plurality of disparate content repositories and workflow systems. Also in a preferred embodiment, the content monitor works by examining the event for information on any change that occurred and if no such information is found the content monitor compares the state of the item or items of the subscription to a XML representation of the state of the item or items previously stored in the meta-data of the subscription to detect change. If change is detected the change is described in both machine-readable (XML) form and human-readable (a written human language) form for use later in the processing of the event. The change descriptions along with the new state of the item or items are be stored in meta-data of the subscription. Preferably, the human-readable change description is generated from the machine-readable change description. In a preferred embodiment, the above-described content monitor is just one of many supplied and possible content monitors that may be used with the system without changing any other aspect of the system.

In a preferred embodiment the system hosts 1 or more event filter plug-in modules that filters uninteresting changes in monitored items. These filters may base their filtering on any criteria but a preferred embodiment provides event filters for many common filtering scenarios such as filtering based on the meta-data values or change of meta-data values of the monitored items, or based on the last time an unfiltered event was processed by the event handlers for this subscription. Also, in a preferred embodiment, the above described filters are just one of many supplied and possible event filters that may be used with the system without changing any other aspect of the system. When multiple filters are defined for the same event path they are processed in a defined serial order, from the least costly to the most costly in terms of impact on the resources of the system.

The system hosts zero or more event handler plug-in modules that handle the interesting change events of the system. Each handler receives the event and has a chance to respond to the event by taking the appropriate action. These handlers may perform any appropriate action but a preferred embodiment will provide event handlers for many common scenarios such as logging, email, commercial or enterprise instant messaging, RSS (Really Simple Syndication or RDF Site Summary) feeds and persisting events for later, on demand, retrieval by the user. In a preferred embodiment, the above described event handlers are just one of many supplied and possible event handlers that may be used with the system without changing any other aspect of the system. When multiple handlers are defined for the same event path they are processed in parallel.

In a preferred embodiment, the system provides the above-described plug-ins with a subscription context. Through the subscription context the plug-ins have access to a live session with the content integration middleware platform, a live session with the workflow integration middleware platform, the APIs for the statistics, error and logging components and to the active subscription that is to be worked on by the plug-in.

In a preferred embodiment, detailed statistics are gathered about the operation of the system. These statistics detail the throughput and operating characteristics of each component of the system and step of the event path. These statistics are critical for monitoring the behavior and health of the system as it is designed to run and provide relevant notification with little or no human intervention or involvement in the process.

In a preferred embodiment, the retrieval and display of these statistics are available to users and administrators through a secure API and the functionality of retrieving and displaying the statistics is also available to administrators and users in a secure graphical user interface and in a web-based user interface.

The ability to have automated notification of interested parties when items, such as content, content organizing structures, work items or work organizing structures are added deleted or changed in a plurality of disparate content repositories, workflow systems and other external information sources is advantageous because people and systems can more quickly respond to change if they are promptly notified. People and systems are also more productive if they do not need to spend time manually monitoring interesting items for change, and people and systems can make better decisions if they are aware that their has been an update of some kind to an item in an enterprise information system that affects their current task. The prior art does not provide a way to support a common event model across the plurality of disparate content repository and workflow systems common in most organizations.

What is claimed is:

1. A system for virtually organizing content, content organizing structures, work items, and/or work organizing structures from a plurality of disparate content repositories and/or workflow systems, the system comprising:
an application program interface (API) for interfacing with a software application written to provide access to the system; and
at least one virtual repository comprising a plurality of nodes that link to select items from the plurality of content repositories and/or workflow systems and provide organizational structure for the virtual repository.

2. The system of claim 1 wherein the content, content organizing structures, work items, and/or work organizing structures are not replicated or impacted by the creation of the at least one virtual repository.

3. The system of claim 1 wherein the existing organization, functions, indexing, and security of the content, content organizing structures, work items, and/or work organizing structures are not impacted by the creation of the at least one virtual repository.

4. The system of claim 1 wherein the API is in a format selected from the group consisting of Java, Component Object Model (COM), Simple Object Protocol (SOAP) Web Services, Representational State Transfer (REST) Web Services, and Web Development Components.

5. The system of claim 1 further comprising a graphical user interface or a web-based interface.

6. The system of claim 1 wherein the nodes are arranged in a parent-child hierarchy.

7. The system of claim 1 wherein each node is of the type selected from the group consisting of links to repository content, links to repository folders, links to workflow system work items, links to workflow system work queues, virtual folders, folders populated by saved repository or workflow system searches, and links to external resources via URLs.

8. The system of claim 1 wherein the nodes contain meta-data properties in addition to the meta-data maintained in their respective underlying content repositories and/or workflow systems that describe how the select items are used in the virtual repository.

9. The system of claim 1 wherein the nodes have supplemental access control rules in addition to the access control rules maintained in their respective underlying content repositories and/or workflow systems, describing how the select items are secured in the virtual repository.

10. The system of claim 1 wherein the at least one virtual repository can be exported to an XML representation and imported from the same XML representation.

11. The system of claim 1 further comprising a middleware platform to abstract the plurality of content repositories and/or workflow systems used in the at least one virtual repository.

12. The system of claim 1 further comprising a set of adaptors to allow the system to access specific content repositories and/or workflow systems.

13. The system of claim 1 further comprising an adaptor toolkit that enables the system to build interfaces to future developed content repositories and/or workflow systems.

14. A system for providing access to workflow in a plurality of disparate workflow systems having a plurality of proprietary program interfaces, the system comprising:
an application program interface (API) for interfacing with a software application written to provide access to the system;
an access services component that relays requests to access workflow items in the plurality of workflow systems from the API to a plurality of bridges; and
a plurality of bridges that translate user requests into requests understandable by the proprietary program interfaces of the plurality of disparate workflow systems.

15. The system of claim 14 wherein the API is in a format selected from the group consisting of Java, Component Object Model (COM), Simple Object Protocol (SOAP) Web Services, Representational State Transfer (REST) Web Services, and Web Development Components.

16. The system of claim 14 further comprising a graphical user interface or a web-based interface.

17. The system of claim 14 further comprising a universal in-box that presents to the user the work items from the plurality of workflow systems intended for that single user based on the users' identity, role membership and group membership in each workflow system of the plurality of workflow systems.

18. The system of claim 14 wherein the access services component maps workflow meta-data properties across the plurality of workflow systems to a single common meta-data property by mapping the name, data type of the property and/or value transformation of the meta-data.

19. The system of claim 14 further comprising an exchange services server that enables import and export of workflow items and meta-data properties in the plurality of workflow systems.

20. The system of claim 14 wherein a single bridge corresponds to a single workflow system.

21. The system of claim 14 further comprising a bridge factory that is configured to generate a new bridge to support each new workflow system.

22. The system of claim 14 wherein each bridge accesses the underlying workflow system via a mode selected from the group consisting of Java, Component Object Model (COM), Java Native Interface (JNI) or Simple Object Access Protocol (SOAP) Web Services.

23. The system of claim 14 further comprising a universal workflow item attachment function that allows content, folders and/or work items from any other content repository and/or workflow system to be attached to a work item.

24. A system for creating rich relationships between two or more pieces of content, content organizing structures, work items and/or work organizing structures that exist in a plurality of content repositories, workflow systems and/or other external information sources, the system comprising an application program interface (API) for interfacing with a software application written to provide access to the system
wherein a system of nodes, members, and associations is used to describe the relationships between the two or more pieces of content, content organizing structures, work items and/or work organizing structures.

25. The system of claim 24 wherein the API is in a format selected from the group consisting of Java, Component Object Model (COM), Simple Object Protocol (SOAP) Web Services, Representational State Transfer (REST) Web Services, and Web Development Components.

26. The system of claim 24 further comprising a graphical user interface or a web-based interface.

27. The system of claim 24 wherein nodes represent content, content organizing structures, work items and/or work organizing structures that can participate in relationships with information selected from the group consisting of meta-data describing the node, roles played in associations with other nodes, 0 or more scoped names, a unique identifier of the subject of the node, a locator of the external subject of the node, and 0 or more node types.

28. The system of claim 24 wherein an association represents a relationship between two or more nodes.

29. The system of claim 28 wherein an association has two or more members which are nodes playing a specific named role in the association.

30. The system of claim 24 wherein members represent the specific role a node plays in an association.

31. The system of claim 30 wherein members have a player specifying the node playing the role in the association.

32. The system of claim 24 wherein associations can have 0 or more association types, wherein the association types have logical properties about the type of the relationship and are selected from the group consisting of allowed cardinality of the relationship, allowed members of the relationship, required members of the relationship, transitivity of the relationship, delete propagation across the relationship, and save propagation across the relationship.

33. The system of claim 24 further comprising locators to reference and de-reference entities external to the system, the locators being selected from the group consisting of a locator for external references that leverages content integration middleware to reference content or content organizing structures from one of a plurality of content repositories, a locator for external references that leverages workflow integration middleware to reference work items or work organizing structures from one of a plurality of workflow systems, and an extensible locator interface to enable locators for any external system

34. A system for providing for notification of one or more event handlers when additions, changes or deletions occur to any subscribed to content, content organizing structures, content repository searches, federated content repository searches, work items, work organizing structures, workflow system searches and/or federated workflow system searches that exist in a plurality of content repositories, workflow systems and/or other external information sources and comprising:
an application program interface (API) for interfacing with a software application written to provide access to the system; and
subscriptions to content, content organizing structures, content repository searches, federated content repository searches, work items, work organizing structures, workflow system searches and/or federated workflow system searches;
wherein the subscriptions are requests to track when additions, changes or deletions occur to any subscribed to content, content organizing structures, content repository searches, federated content repository searches, work items, work organizing structures, workflow system searches and/or federated workflow system searches.

35. The system of claim 34 wherein the subscriptions are stored with information selected from the group consisting of meta-data describing the subscription, stored and encrypted user credentials to be used when later detecting change of the subscribed item, stored state representation of the item from the last time it was monitored for change, with an XML version of the stored state representation, and with membership in a logical subscription group.

36. The system of claim 34 wherein the API is in a format selected from the group consisting of Java, Component Object Model (COM), Simple Object Protocol (SOAP) Web Services, Representational State Transfer (REST) Web Services, and Web Development Components.

37. The system of claim 34 further comprising a graphical user interface or a web-based interface.

38. The system of claim 34 wherein logical groups organize like subscriptions with a common polling interval for a group or with a common event path for a group.

39. The system of claim 34 further comprising an event path defined per logical group comprising a timer, group processor, content monitor, event filter and event handler components.

40. The system of claim 39 wherein the timer initiates periodic polling of content repositories and workflow systems for change that needs notification.

41. The system of claim 39 wherein the group processor initiates events on eligible subscriptions in a subscription group.

42. The system of claim 39 wherein the content monitor comprises a plug-in module for detecting change in monitored items.

43. The system of claim 39 wherein the event filter comprises plug-in modules for filtering interesting and uninteresting changes in monitored items.

44. The system of claim 39 wherein a subscription context is made available to event path plug-ins, content monitors, event filters, and event handlers with access selected from the group consisting of access to a live content integration middleware session, access to a live workflow integration middleware session, access to a statistics reporting API, access to an error reporting API, access to a logging API, and access to the active subscription for the plug-in

45. The system of claim 34 further comprising a statistics module for gathering runtime statistics on events passing through each step of an event path and displaying said statistics.

46. The system of claim 34 wherein an event is created when a change is detected with the subscription for the event, meta-data describing the event, an event path the event will follow, and an open schema so that content repositories or workflow systems with internally defined event mechanisms can post events to the federated event system without polling for change.
